(19) United States
(12) Patent Application Publication
(10) Pub. No.: US 2006/0039624 A1
(43) Pub. Date: Feb. 23, 2006

(54) System and method for fuzzy filtering images

(76) Inventors: Hao-Song Kong, Newton, MA (US); Yao Nie, Newark, DE (US); Anthony Vetro, Cambridge, MA (US)

Correspondence Address: Mitsubishi Electric Research Laboratories, Inc.;Patent Department, 201 Broadway, Cambridge, MA, 02139, US

(21) Appl. No.: 10/923,483

(22) Filed: Aug. 20, 2004

(51) Int. Cl. G06K 9/40

(52) U.S. Cl. 382/274; 382/260

(57) ABSTRACT

An invention provides a system and method for filtering pixels in an image using only fixed-point and summation operations. First, a filtering window is centered on an input pixel. Based on a difference between the intensity of the input pixel and its neighboring pixels, fuzzy filter weights are obtained. A sum of the fuzzy filter weights is used to determine a normalization factor. Then, the pixel intensities, fuzzy filter weights and the normalization factor are used to obtain an output pixel corresponding to the input pixel.

### FIELD OF THE INVENTION

The present invention relates generally to digital signal processing, and more particularly to reducing visual artifacts in compressed images and videos.

### BACKGROUND OF THE INVENTION

Compressed images and videos are used in many applications, such as digital cameras, HDTV broadcast and DVDs. Compression provides efficient channel and memory utilization. Most image/video coding standards, such as JPEG, ITU-T H.26× and MPEG-1/2/4, use block-based processing for the compression. However, visual artifacts, such as blocking noise and ringing noise occur in decompressed images due to the underlying block-based coding, coarse quantization, and coefficient truncation.

Post-filtering techniques can remove the blocking and ringing artifacts. A number of post-filtering methods are known. However, those methods either introduce undesirable blurring, or cannot remove all types of visual artifacts.

To address this problem, an edge map guided adaptive and fuzzy filtering method is described in U.S. patent application Ser. No. 10/832,614, “System and Method for Reducing Ringing Artifacts in Images,” filed by Kong et al., on Apr. 27, 2004.

As shown in FIG. 1, that method generates an edge map for each input image 101 in a block classification module 102 by computing a local variance within a 3×3 window centered at each pixel. A pixel is determined to be an edge pixel if the corresponding variance is higher than a predetermined threshold. Each image is divided into non-overlapping 8×8 blocks. An 8×8 block is declared to be an edge block if at least one edge pixel is present in the block, otherwise the block is a non-edge block. To remove the blocking artifacts, an adaptive 1-D filtering 103 is applied along all of the 8×8 block boundaries. Then, an edge block test 104 is applied. If the block is classified as an edge block, then a fuzzy filtering 105 is applied to reduce ringing artifacts near the edges. If the block is not classified as an edge block, then no further filtering is applied. This filtering process yields a filtered output image 106.

In that prior art method, an output of the fuzzy filter is defined as:

$$y = \frac{{\sum }_{j = 1}^{N} {x}_{j} {w}_{j}}{{\sum }_{j = 1}^{N} {w}_{j}} = \frac{{\sum }_{j = 1}^{N} {x}_{j} \cdot exp [ - {( {x}_{c} - {x}_{j} )}^{2} \text{/} ( 2 {ξ}^{2} ) ]}{{\sum }_{j = 1}^{N} exp [ - {( {x}_{c} - {x}_{j} )}^{2} \text{/} ( 2 {ξ}^{2} ) ]} , \qquad ( 1 )$$

where N is a total number of samples in a filtering window, xⱼ are sample values, wⱼ=exp[−(x_{c}−xⱼ)²/(2ξ²)] are filter weights, x_{c}∈{x₁, x₂, . . . x_{N}} is a value of a sample spatially located at a center of a filtering window, and ξ is referred to as a spread parameter of the filter. Because the fuzzy filter preserves strong edges while smoothing weak edges, the filter can effectively suppress the ringing artifacts, without corrupting the image edges.

Compared to other prior art post-filtering methods, the Kong method achieves superior image quality and reduces the computational complexity by avoiding filtering non-edge blocks. However, direct implementation of fuzzy filtering requires N evaluations of the exponential function (1) to obtain the filter weights for each pixel. This is computationally complex and consumes time. Moreover, because the filter weights wⱼ for j=1, . . . , N, are real numbers, floating-point multiplication and division operations are needed. Also, the division operation is undesirable because the operation is a time consuming, multi-cycle process on microprocessors, consuming a large amount of processing power and resources. The floating-point arithmetic is also not desirable, because it requires a more expensive processor than is used for fixed-point arithmetic.

An approximation of an exponential function is described in U.S. Pat. No. 5,824,936, “Apparatus and Method for Approximating an Exponential Decay in A Sound Synthesizer,” issued to DuPuis et al, on Oct. 20, 1998. That method simplifies an exponential decay phenomenon in a sound synthesizer, so that only add and shift operations instead of multiplication operations are used. That approximation exploits a characteristic of the exponential function that, at equal time intervals, a ratio of a parameter value at the beginning of the time interval to the parameter value at the end of the time interval remains constant. That method includes selection of a constant interval of time and selection of a constant ratio between the parameter value at the beginning of the constant interval and the parameter value at the end of the constant interval.

However, that method is not applicable to fuzzy filtering because the desired linear approximation for calculating the fuzzy filter weights are closely associated with, and must be adaptive to, the spread parameter so that the smoothing effects of the fuzzy filter can be controlled by adjusting the spread parameter. Spread parameters are not considered by DuPuis.

For the division-free problem, one method is described in U.S. Pat. No. 5,903,480, “Division-free Phase-shift for Digital-audio Special Effects,” issued to Lin on May 11, 1999. In that method, digital audio input signals are filtered by a series of infinite input response (IIR) filters with a transfer function

$$\frac{C ( n ) - {z}^{- 1}}{1 - C ( n ) \cdot {z}^{- 1}} .$$

The transfer function is expressed in a frequency domain, and a variable z is a delay factor. The filter coefficient C(n) is repeatedly re-generated from the function

$$C ( n ) = \frac{1 - P ( n )}{1 + P ( n )} ,$$

where P(n) are sweep coefficients. The sweep coefficients satisfy following relations:
P(0)=Pmin, P(n)=P(n−1)*p; and
p is referred to as up-sweep constant, which is greater than one. If P(n) reaches the maximum value Pmax, then P(n) is swept down by a down-sweep constant q, so that P(n)=P(n−1)*q.

To avoid a division operation in computing the filter coefficient C(n), that method obtains the filter coefficient in the following way:

$$Let$$

$$C min = \frac{1 - P max}{1 + P max} , C max = \frac{1 - P min}{1 + P min} , and r = \frac{1 - p}{1 + p} ,$$

during the down-sweep. C(n) is recursively calculated as
C(0)=Cmin, C(n+1)=C(n)−r[1−C(n)*C(n)],
until C(n+1) reaches Cmax. During the up-sweep C(n) is recursively calculated as
C(n+1)=C(n)+r[1−C(n)*C(n)].
Thus, that method is only applicable to the specific filter used in that particular application, and cannot work for a fuzzy filter structure.

A method for converting a floating-point filter to a fixed-point filter is described in in U.S. Pat. No. 6,711,598, “Method and System for Design and Implementation of Fixed-point Filter for Control and Signal Processing,” issued to Paré, Jr. et al, on Mar. 23, 2004. In that method, a sequence for designing a fixed-point filter for a system is selected. Then, a low-order floating-point filter and a first set of parameters associated with the low-order floating-point filter components are selected. One or more parameters of a first set of parameters are modified iteratively to obtain a set of modified parameters, until performance characteristics calculated using the first set of parameters meets a performance objective of the fixed-point filter for the system. Because fuzzy filter coefficients are adaptive to the input data and the system is highly dynamic, that method cannot be used, and the iterative characteristics of that method are very undesirable for a fuzzy filter.

Therefore, it is desired to obtain fuzzy filter weights without evaluating an exponential function, while achieving good approximations of the filter weights that minimize degradation of image quality. It is also desired to obtain filter weights using only fixed-point integer operations.

### SUMMARY OF THE INVENTION

The invention provides a system and method for filtering pixels in an image using only fixed-point and summation operations. First, a filtering window is centered on an input pixel. Based on a difference between the intensity of the input pixel and its neighboring pixels, fuzzy filter weights are obtained. A sum of the fuzzy filter weights is used to determine a normalization factor. Then, the pixel intensities, fuzzy filter weights and the normalization factor are used to obtain an output pixel corresponding to the input pixel.

The fuzzy filter weights are determined in two ways, each of which approximates an exponential function. The first method involves a look-up table, which stores the predetermined fuzzy filter weights in a table and indexes the weights using integer values. The weights are selected by mapping the difference to the index in the look-up table. The size of the look-up table itself can be reduced by setting values lower than a predetermined threshold to zero. The second method uses the difference to evaluate a linear approximation of the exponential function to obtain the fuzzy filter weights.

### BRIEF DESCRIPTION OF THE DRAWINGS

FIG. 1 is a block diagram of the prior art edge-map guided adaptive and fuzzy filtering method for reducing visual artifacts in compressed images;

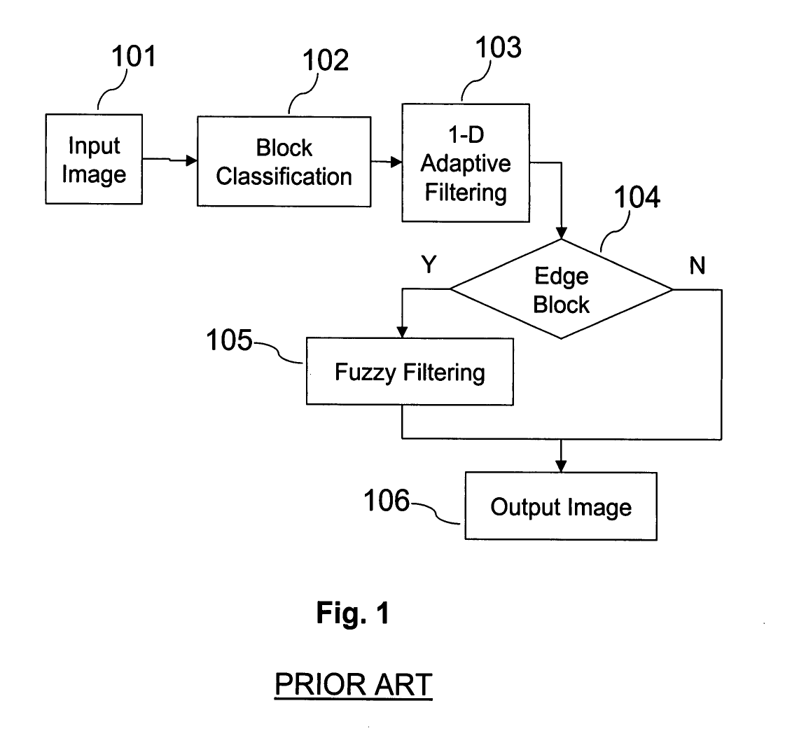

FIG. 2 is a block diagram of fuzzy filtering according to the invention;

FIG. 3A is a block diagram of a look-up method used to obtain filter weights according to the invention;

FIG. 3B is a block diagram of a linear approximation method used to obtain filter weights according to the invention;

FIG. 4 is a graph comparing piecewise linear approximation and a Gaussian function; and

FIG. 5 is a block diagram of a normalization method for filter weights according to the invention.

### DETAILED DESCRIPTION OF THE PREFERRED EMBODIMENT

The invention provides a system and methods for implementing a fuzzy filter for filtering images and videos that have been compressed. The invention can obtain efficiently fuzzy filter weights and determine a filter output using only fixed-point and summation operations. The invention is particularly useful for reducing visual artifacts in decompressed images and videos.

The invention provides two alternative methods to obtain efficiently the adaptive fuzzy filter weights. A first method uses a look-up table (LUT), and a second method uses a linear approximation (LA).

The LUT stores fuzzy filter weight values, which are indexed by ‘differences’ between pixel intensities. A technique that reduces memory requirements for the LUT is also described. The LUT method requires a minimal amount of computation, and is suitable for fuzzy filters with a fixed spread parameter.

The LA method approximates an exponential function, which is completely determined by a spread parameter of the exponential function. The LA method is useful for fuzzy filters with a variable spread parameter, and only requires computation of linear functions to obtain the filter weights.

The invention incorporates the LUT and LA methods into a system that determines an output of the fuzzy filter using only integer summation, integer multiplication and bit-shift operations. This is achieved by mapping a sum of the scaled fuzzy filter weights to an integer-valued normalization factor and calculating normalized weighted sums of input pixels. Finally, the normalized weighted sums are recovered using bit shifting to obtain the output of the filter.

System Overview

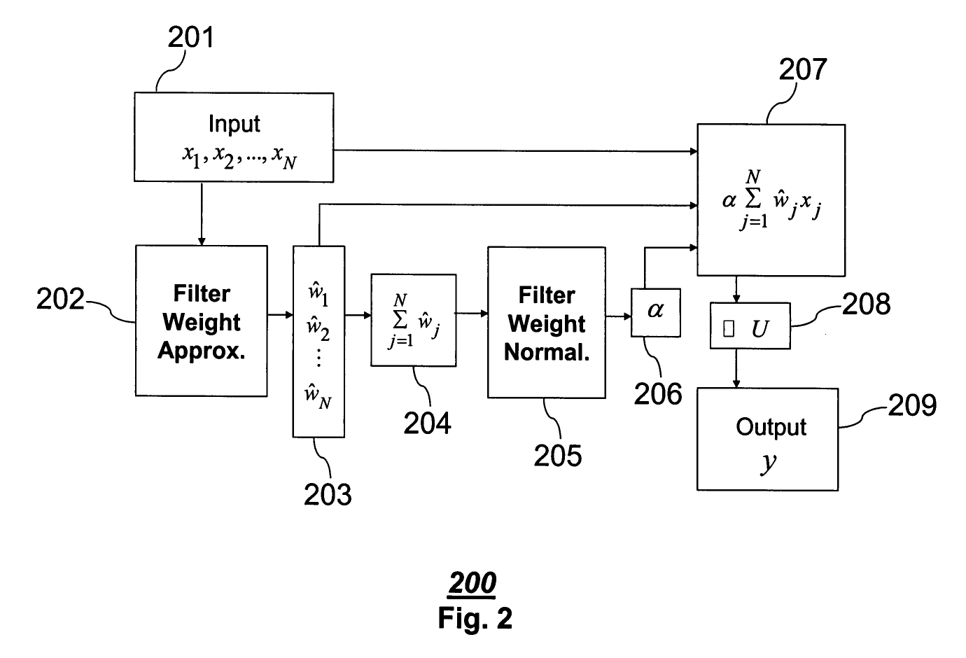

FIG. 2 shows a fuzzy filtering system 200 according to the invention. Inputs 201 are the N pixels xᵢ, i=1, 2, . . . , N in a filtering window centered at a pixel in the input image 101. If the window size is n×n, then N=n². We assume that each pixel value is represented by an M-bit integer. The output is the filtered pixel y 209.

The object of this system 200 is to compute the fuzzy filter output y 209 by performing only integer summation, multiplication and bit shift operations, such that

$$y = \frac{{\sum }_{j = 1}^{N} {x}_{j} {w}_{j}}{{\sum }_{j = 1}^{N} {w}_{j}} \approx ( α {\sum }_{j = 1}^{N} {x}_{j} {\hat{w}}_{j} ) • U , \qquad ( 2 )$$

where ŵ₁, ŵ₂ . . . , ŵ_{N}, α, and U are all positive integers, and □ U means shifting U bits to the right, i.e., to the low order bits.

To perform the filtering, the input pixels 201 are subject to a filter weight approximation module 202 to obtain a corresponding N integer valued fuzzy filter weight vector 203. Then, a sum 204 of the N integer valued weights 203 is determined. The sum is used in a filter weight normalization module 205 to obtain an integer valued normalization factor α 206. Finally, the input pixels 201, the integer fuzzy filter weight vector 203, and the normalization factor 206 are used to determine a normalized weighted sum 207. The normalized weighted sum is right shifted by U bits 208 to obtain the output pixel y 209.

Filter Weights Approximation

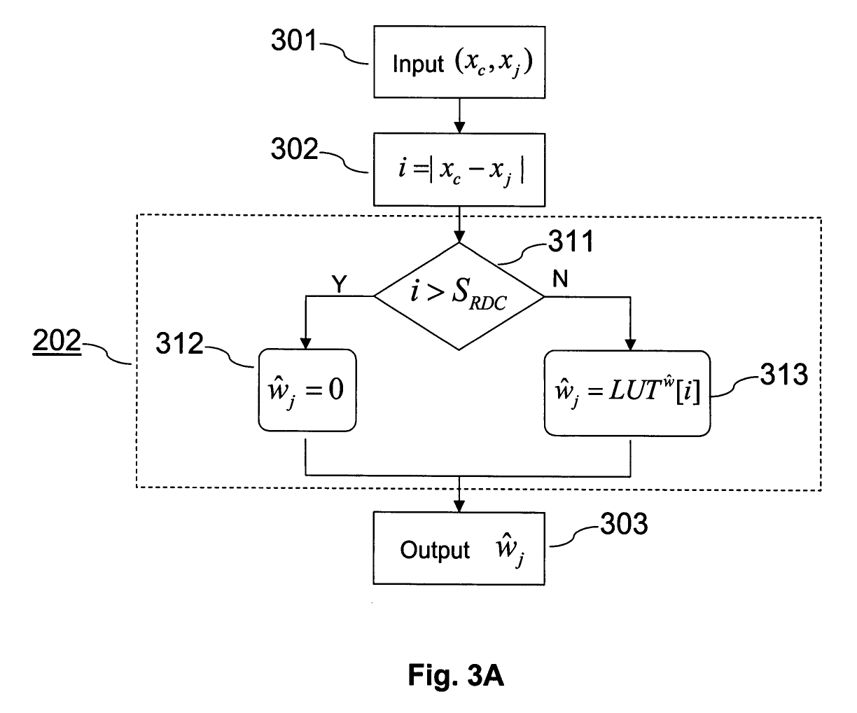

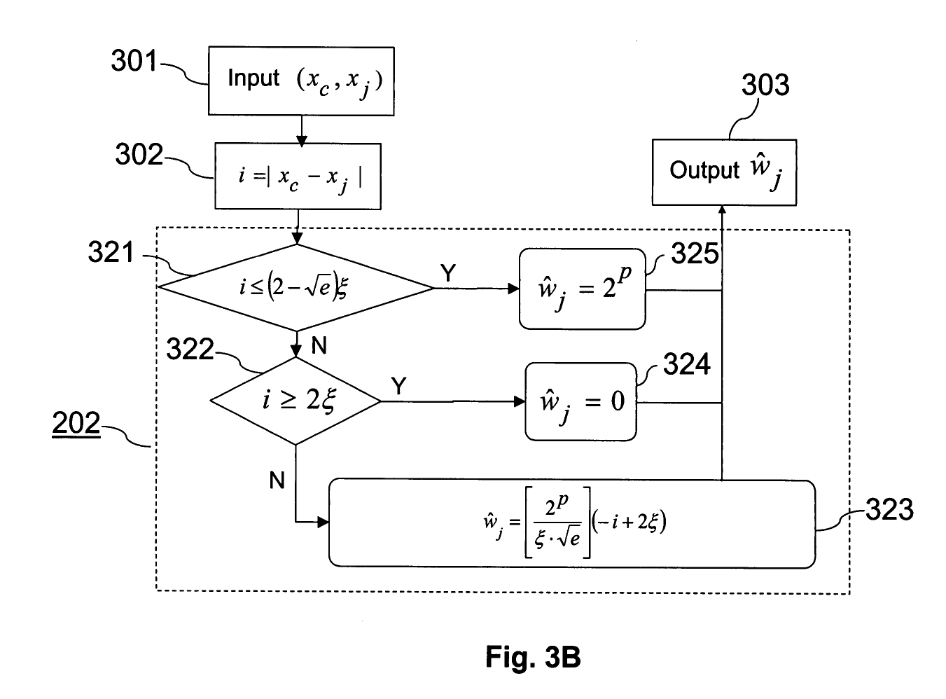

The present invention includes two methods used in the filter weight approximation module 202 to obtain the integer valued fuzzy filter weights: the look-up table (LUT) method and the linear approximation (LA) method, which are shown in FIG. 3A and FIG. 3B, respectively.

For both methods, referring to either FIG. 3A or FIG. 3B, the input 301 is a pixel intensity pair (x_{c}, xⱼ) from the input pixels 201. A difference between the pair of pixels is i=|x_{c}−xⱼ| 302. An output is a fuzzy filter weight ŵⱼ 303, which is one of the elements in the fuzzy filter weight vector 203. The N pixel intensity pairs, i.e., (x_{c}, xⱼ), i=1, 2, . . . , N, are used sequentially to obtain all of the elements of the fuzzy filter weight vector 203.

LUT Method

Referring to FIG. 3A, the difference i 302 is used as an index for the look-up table. If the difference i is greater 311 than a size SRDC of the look-up table, then the output fuzzy filter weight is assigned 312 a zero value. Otherwise, the fuzzy filter weight is assigned 313 to the i^{th} entry in the look-up table LUT^{ŵ}.

The LUT method is based on the following observation. Note that the pixel intensity value is represented by M-bit integers, e.g., M=8 in most cases, where there are 2^{M} possible integer values total for the difference i=|x_{c}−xⱼ| in the range [0, 2^{M}−1]. Therefore, for a fixed spread parameter ξ, the fuzzy filter weights also take 2^{M} possible values. These values can be pre-calculated, scaled, rounded to integers, stored in the look-up table LUT^{ŵ}, and indexed by the pixel difference so that LUT^{ŵ}[i]=└2^{p}·exp(−i²/2ξ²)┘, where i=0, 1, . . . , 2^{M}−1, [ ] is a rounding operation, and the scaling factor 2^{p} is selected to achieve an appropriate precision. The fuzzy filter weight ŵⱼ is obtained by mapping the difference index i=|x_{c}−xⱼ| to the corresponding weight value in the look-up table LUT^{ŵ}.

For an M-bit pixel intensity value, a size of a full LUT^{ŵ} is S_{FULL}=2^{M} (S_{FULL}=256 for M=8). Considering that the filter output only requires integer precision, the size of LUT^{ŵ} can be reduced to favor a hardware implementation without significantly influencing the precision of the output. The reduction in size is based on the following observation. Rewriting the original fuzzy filter expression given by equation (1) as:

$$y = \frac{{\sum }_{j = 1}^{N} {x}_{j} {w}_{j}}{{\sum }_{j = 1}^{N} {w}_{j}} = {\sum }_{j = 1}^{N} {x}_{j} {c}_{j} ,$$

where

$${c}_{j} = {w}_{j} \text{/} {\sum }_{j = 1}^{N} {w}_{j} .$$

The j^{th} term xⱼcⱼ is negligible if xⱼcⱼ<1, which means wⱼ can be set to zero if

$${w}_{j} < {\sum }_{j = 1}^{N} {w}_{j} \text{/} {x}_{j} .$$

Note that for

$${\sum }_{j = 1}^{N} {w}_{j} \geq 1 and {x}_{j} \leq {2}^{M} - 1 ,$$

the lower bound of

$${\sum }_{j = 1}^{N} {w}_{j} \text{/} {x}_{j} is 1 \text{/} ( {2}^{M} - 1 ) .$$

Therefore, the original real-valued fuzzy filter weights lower than 1/(2^{M}−1), a predetermined parameter, can be set to zero and need not be scaled, rounded or stored. These values correspond to the intensity difference values greater than ξ\sqrt{2ln(2^{M}−1)}, where ξ is the spread parameter. Hence, the size of the look-up table LUT^{ŵ} can be reduced to S_{RDC}=[ξ\sqrt{2ln(2^{M}−1)}]. For example, with M=8 and ξ=20, the reduced size of the lookup table LUT^{ŵ} is S_{RDC}=67.

LA Method

Referring to FIG. 3B, if the difference i=|x_{c}−xⱼ| 302 is smaller than or equal to 321 a threshold (2−\sqrt{e})ξ, then the output fuzzy filter weight is assigned 325 a value of 2^{p}. If the difference i 302 is greater than or equal to 322 a threshold 2ξ, then the output fuzzy filter weight is assigned 324 a value of zero. If neither condition 321 or 322 is satisfied, then the output fuzzy weight is assigned 323 by a linear function

$${\hat{w}}_{L} ( i ) = [ \frac{{2}^{p}}{ξ \cdot \sqrt{e}} ] ( - i + 2 ξ ) , \text{(} 2 - \sqrt{e} \text{)} ξ < i < 2 ξ .$$

Details of the above method are described further below. In the LA method, a Gaussian exponential function w_{G}(i)=exp(−i²/(2ξ²) (i≧0) is approximated by a piecewise linear function, which is defined as

$${w}_{L} ( i ) = \{ \begin{matrix}1 , & 0 \leq i \leq \text{(} 2 - \sqrt{e} \text{)} ξ \\ \frac{1}{ξ \cdot \sqrt{e}} ( - i + 2 ξ ) , & \text{(} 2 - \sqrt{e} \text{)} ξ < i < 2 ξ \\ 0 , & i \geq 2 ξ\end{matrix} \qquad ( 3 )$$

The geometrical explanation of the approximation is as follows. The line segment determined by the linear function

$$\frac{1}{ξ \cdot \sqrt{e}} ( - i + 2 ξ )$$

intersects with the Gaussian function w_{G}(i) at a point [ξ, w_{G}(ξ)]. At this point, the second derivative of the Gaussian function w_{G}(i) is zero, i.e., w″_{G}(ξ)=0. In addition, the slope of the line segment is actually the same as the first derivative of the function w_{G}(i) at ξ, i.e., w′_{G}(ξ)=−\sqrt{e}/ξ. The linear function is then truncated to fit an un-scaled fuzzy filter weights range [0, 1] resulting in the above formulations. Thus, the piecewise linear function is determined by the spread parameter ξ.

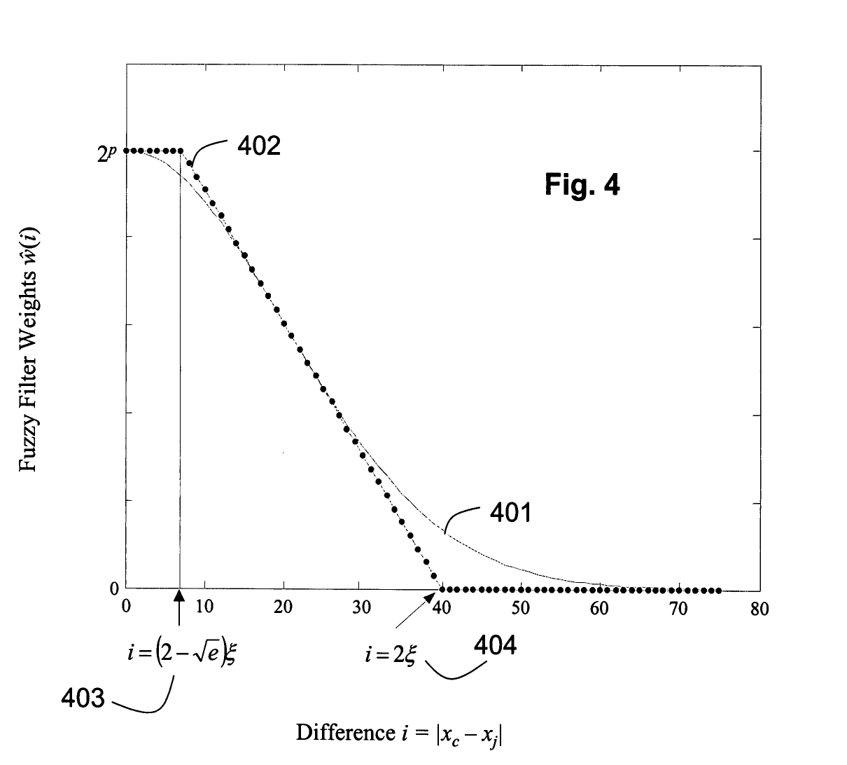

FIG. 4 shows the exponential function 401 and the corresponding piecewise linear approximation 402 according to the invention. In this figure, the horizontal axis represents the difference i, the vertical axis represents the fuzzy filter weights ŵ(i), which have a range [0, 2^{p}], and ξ is twenty. To obtain the integer valued fuzzy filter weights, the linear function w_{L}(i) is scaled by 2^{p}, rounded and is re-defined as:

$${\hat{w}}_{L} ( i ) = \{ \begin{matrix}{2}^{p} , & 0 \leq i \leq \text{(} 2 - \sqrt{e} \text{)} ξ \\ [ \frac{{2}^{p}}{ξ \cdot \sqrt{e}} ] ( - i + 2 ξ ) , & \text{(} 2 - \sqrt{e} \text{)} ξ < i < 2 ξ \\ 0 , & i \geq 2 ξ\end{matrix} . \qquad ( 4 )$$

This piecewise function 402 approximates the scaled exponential function ŵ_{G}(i)=2^{p}·exp(−i²/(2ξ²), (i≧0) 401. For differences i less than or equal to (2−\sqrt{e})ξ 403, the fuzzy filter weight is 2^{p}. For differences i greater than or equal to 2ξ 404, the fuzzy filter weight is zero. If the difference i falls between (2−\sqrt{e})ξ and 2ξ, then the fuzzy filter weight is determined by the linear function as above. For a fixed spread parameter ξ and scaling factor 2^{p}, equation (4) becomes a linear function with constant integer coefficients and is simple to compute.

Comparison of the LUT and LA Methods

The LUT method requires fewer operations than the LA method. However, the LUT method requires memory to store the predetermined look-up tables for each spread parameter. Therefore, the LUT method is better suited for fuzzy filtering with a fixed spread parameter, or with a small set of spread parameters.

In contrast, the LA method does need to store look-up tables. However, the LUT method requires more operations than the LUT method. Both methods achieve the same image quality. Thus, the selected method can depend on the application requirements.

Users can choose the more suitable method according to memory requirements and the desire to vary the spread parameter.

Filter Weights Normalization

In the filter weights normalization module 205, the sum of the integer fuzzy filter weights is mapped to a normalization factor by using a look-up table, LUT^{α}. Because the size of LUT^{α} is restrained to favor hardware implementation, the sum is rescaled in order to fit the range of LUT^{α}. Then, the rescaled sum is used to determine the index. The index is used to retrieve the corresponding normalization factor in the look-up table LUT^{α}.

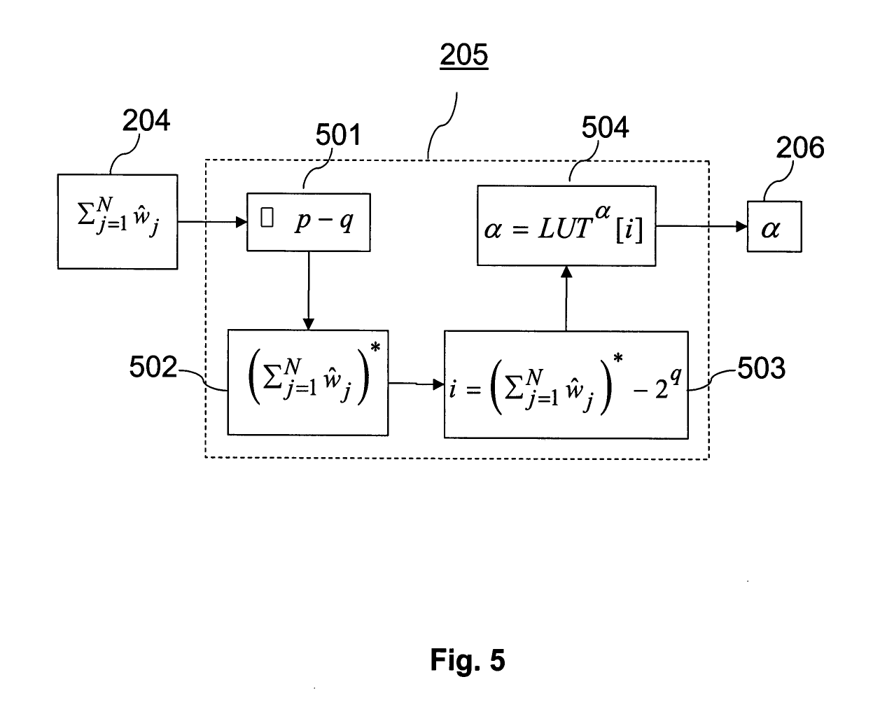

Referring to FIG. 5, the sum of the integer fuzzy filter weights 204 is shifted to the right by (p−q) bits 501 to obtain the rescaled sum (Σⱼ₌₁^{N}ŵⱼ)* 502. Here, the user defined parameter p is used in the filter weight approximation module 202, the user defined parameter q is associated with the look-up table, such that the rescaled sum of the filter weights has a range [2^{q}, 2^{q}·N], and a size of LUT^{α} is 2^{q}(N−1). Note that q≦P. The index i is obtained by i=(Σⱼ₌₁^{N}ŵⱼ)*−2^{q} 503. The corresponding normalization factor α 206 is the i^{th} entry 504 in the look-up table. The entries in the LUT^{α} are predetermined such that
LUT^{α}[i]=[2^{u}/(i+2^{q})]=[2^{u}/(Σⱼ₌₁^{N}ŵⱼ) *],
where i=0, . . . , 2^{q}(N−1). A value u=log₂N+q+r is user-defined so that the factor α has a precision of ½^{r}.

Filter Output

The input pixels 201, the integer fuzzy filter weight vector 203, and the normalization factor 206 are used to determine the normalized weighted sum

$$α {\sum }_{j = 1}^{N} {\hat{w}}_{j} {x}_{j} 207.$$

The sum is shifted to the right by U bits 208 to obtain the output 209, where U=u+p−q.

Guidelines for Parameter Selection

The invention has four user defined parameters ξ, p, q, and u (or r), which can be set according to the following guidelines.

Selection of ξ: This parameter controls the fuzzy filter smoothing ability. The larger the ξ, the stronger the smoothing effects. A very large ξ can over-smooth the image, while too small a value may not remove ringing effects. The preferred range for ξ is 15˜25. It is also advised that as the reduced size of the look-up table LUT^{ŵ} is determined by ξ, the user can select ξ according to memory availability.

Selection of p: This parameter determines the precision of the integer fuzzy filter weights ŵⱼ. The larger the value, the higher the precision level. However, if the parameter p is very large, the weight value may exceed the integer range. Also, p should not be too small, and should satisfy

$$\frac{{2}^{p}}{ξ \cdot \sqrt{e}} > 0.$$

A preferred value is six.

Selection of q: This parameter determines the precision of the rescaled weighed sum of the input (Σⱼ₌₁^{N}ŵⱼ)* and the size of the look-up table LUT^{α}. The value q should be small enough so that the look-up table size satisfies memory availability, and q also should be large enough to achieve sufficient precision. The preferred value is four.

Selection of r: This parameter determines the precision of the normalization factor α, where a larger value implies a higher precision level. It should not be too large and make α exceed the integer range. The preferred value is five.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for filtering pixels in an image, each pixel having an associated intensity, comprising the steps of:
centering a filtering window on an input pixel, the filtering window including the input pixel and a plurality of neighboring pixels adjacent to the input pixel;
determining a weight for each pixel in the filtering window, each weight being an integer;
summing the weights;
mapping the summed weights to a normalization factor;
multiplying the weight and the intensity of each pixel in the filtering window to obtain a product for each pixel in the filtering window;
summing the products; and
multiplying the summed products by the normalization factor to obtain an intensity of an output pixel corresponding to the input pixel.

2. The method of claim 1, further comprising:
basing the weights on an exponential function.

3. The method of claim 2, further comprising:
approximating the exponential function by a look-up table.

4. The method of claim 2, further comprising:
approximating linearly the exponential function.

5. The method of claim 3, in which the look-up table includes the weights indexed by integers, and further comprising:
measuring, for each pixel in the filtering window, a difference between the intensity of the pixel and the intensity of the input pixel; and
selecting the weight by mapping the difference to the index of the weight in the look-up table.

6. The method of claim 5, in which the look-up table has a full size S_{FULL}=2^{M}, where M is the number of bits used to represent the intensity of the input pixel.

7. The method of claim 5, in which the look-up table has a reduced size where weights less than a predetermined threshold are defined as zero.

8. The method of claim 4, further comprising:
measuring, for each pixel in the filtering window, a difference between the intensity of the pixel and the intensity of the input pixel; and
generating the weight by evaluating the linear approximation according to the difference.

9. The method of claim 2, further comprising:
controlling the exponential function with a spread parameter.

10. The method of claim 9, in which the spread parameter is twenty.

11. The method of claim 9, in which the spread parameter is variable according to each pixel in the filtering window.

12. The method of claim 1, in which a size of the filtering window is three by three pixels.

13. The method of claim 1, in which a size of the filtering window is variable.

14. The method of claim 1, in which the weights are integers.

15. The method of claim 2, in which the exponential function represents a fuzzy filter.

16. A system for filtering pixels in an image, each pixel having an associated intensity, comprising:
means for centering a filtering window on an input pixel, the filtering window including the input pixel and a plurality of neighboring pixels adjacent to the input pixel;
means for determining a weight for each pixel in the filtering window, each weight being an integer;
a first adder for summing the weights;
means for mapping the summed weights to a normalization factor;
a first multiplier for multiplying the weight and the intensity of each pixel in the filtering window to obtain a product for each pixel in the filtering window;
a second adder for summing the products; and
a second multiplier for multiplying the summed products by the normalization factor to obtain an intensity of an output pixel corresponding to the input pixel.
